(19) United States
(12) Patent Application Publication
(10) Pub. No.: US 2026/0179228 A1
(43) Pub. Date: Jun. 25, 2026

(54) VEHICULAR VISION SYSTEM WITH CAMERA CALIBRATION

(71) Applicant: Magna Electronics Inc., Auburn Hills, MI (US)

(72) Inventors: Tao-I Hsu, Oakville (CA); James Turk, Oakville (CA); Liang Zhang, Ottawa (CA)

(21) Appl. No.: 19/424,516

(22) Filed: Dec. 18, 2025

Related U.S. Application Data
(60) Provisional application No. 63/736,179, filed on Dec. 19, 2024.

(51) Int. Cl. G06T 7/13; B60R 11/04; G06T 7/143; G06T 7/60; H04N 23/57

(52) U.S. Cl. CPC G06T 7/13; B60R 11/04; G06T 7/143; G06T 7/60; H04N 23/57; G06T 2207/30252

(57) ABSTRACT

A vehicular vision system includes a camera disposed at a vehicle equipped with the vehicular vision system and viewing exterior of the vehicle, the camera capturing image data. The system includes an electronic control unit (ECU) with electronic circuitry and associated software. The electronic circuitry of the ECU includes an image processor for processing image data captured by the camera to detect presence of objects within a field of view of the camera. The vehicular vision system, at least in part via processing at the ECU of image data captured by the camera, detects edges of an object. The vehicular vision system, based at least in part on the detected edges of the object extracts lines representative of the detected edges and performs slope-based validation of the extracted lines. The vehicular vision system determines corners of the object by determining intersections of the validated extracted lines.

### CROSS REFERENCE TO RELATED APPLICATION

The present application claims the filing benefits of U.S. provisional application Ser. No. 63/736,179, filed Dec. 19, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes a camera disposed at a vehicle. The vehicular vision system views exterior of the vehicle, the camera capturing image data. The camera includes an imager including a CMOS imaging array having at least one million photosensors arranged in rows and columns. An electronic control unit (ECU) includes electronic circuitry and associated software. The electronic circuitry of the ECU includes an image processor for processing image data captured by the camera to detect presence of objects within a field of view of the camera. At least in part via processing at the ECU of image data captured by the camera, the vehicular vision system detects edges of an object. Based at least in part on the detected edges of the object, the vehicular vision system extracts lines representative of the detected edges and performs slope-based validation of the extracted lines. The vehicular vision system determines corners of the object by determining intersections of the validated extracted lines.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2A is a series of frames of image data captured by a front camera, where the field of viewing of the front camera is rotated −5° from its base orientation;

FIG. 2B is a series of frames of image data captured by a rear camera, where the field of viewing of the rear camera is rotated −5° from its base orientation;

FIG. 2C is a series of frames of image data captured by a front camera, where the field of viewing of the front camera is rotated +5° from its base orientation;

FIG. 2D is a series of frames of image data captured by a rear camera, where the field of viewing of the rear camera is rotated +5° from its base orientation; and

FIGS. 3A and 3B illustrates a flowchart of an example of operations for a method of camera calibration including corner detection and line extraction.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

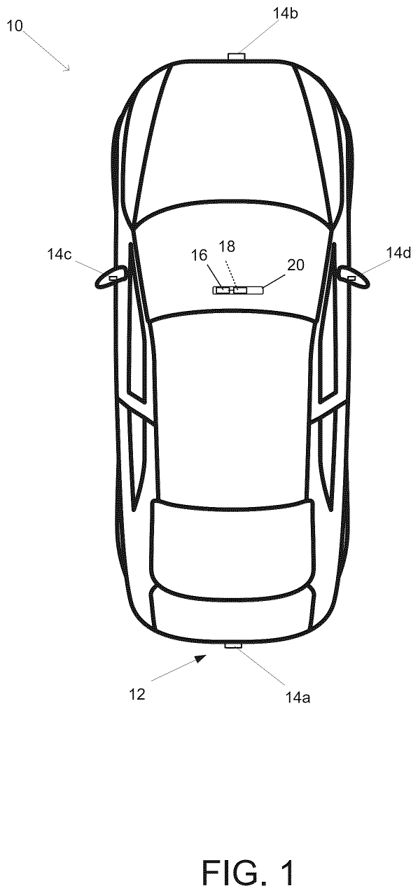

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The image data captured by the camera includes pixels of data, where each pixel of the captured image data represents a respective point in the image represented by the image data. Each pixel has an intensity representing the intensity of light received at a photosensor of the camera. The relative intensity of pixels may have a gradient, where the gradient of the pixels includes the rate and direction of change in pixel intensity. The data transfer or signal communication from the camera to the ECU may comprise any suitable data or communication link, such as a vehicle network bus or the like of the equipped vehicle.

Calibrating an image sensor or camera, such as vehicular camera calibration of the vision system 12, may include implementation of image processing techniques for detecting corners of objects located in a field of sensing of the camera (i.e., corner detection). Camera calibration may also include extracting lines from distorted calibration targets, such as objects located in the field of sensing (i.e., line detection, line segment detection, and/or line extraction). Camera calibration may include more than intrinsic and extrinsic calibration processes, such as calibrating for robust performance in environments prone to noise, lighting variation, and optical distortions. That is, applications span intrinsic and extrinsic calibration tasks, with robust performance in environments prone to noise, lighting variation, and optical distortions.

Noise may include glare from ambient light, relative motion between the camera and the object in the field of sensing of the camera, soiling or occlusion of a lens of the camera, and/or errors in the transmission or capture of image data. Lighting variation may occur as the equipped vehicle 10 travels between environments that have different lighting conditions, such as moving from a garage or a low brightness environment into sunlight or a high brightness environment, variation in lighting caused by the rising and setting of the sun, or light exposure from headlights or taillights of other vehicles or streetlights. Optical distortions may include distortions caused by a shape of the camera lens, such as a wide-angle lens or a fisheye lens, or distortions caused by light reflecting from objects such as water, glass, other vehicles, or mirrors.

The camera calibration methods and systems and the vision systems described herein include robust corner detection and line extraction. Particularly, the calibration systems and methods and vision systems described herein may be applied to vehicular camera calibration. The camera calibration methods and systems utilize edge drawing (ED) for continuous edge linking. The camera calibration may also include slope-constrained line validation and intersection-based corner detection. Optionally, line validation may include determining whether a line is angularly aligned with a determined edge. ED, edge linking, slope-constrained line validation, and intersection-based corner detection result in high precision and reliable image sensing under a variety of environmental conditions. The camera calibration may compensate for conditions such as fisheye distortions and pixel-shift biases, integrating seamlessly with calibration frameworks to enhance ground-plane-orientation calculations and re-projection error minimization. The camera calibration may further include sub-pixel refinement and distortion correction, transforming the process of camera calibration.

Corner detection techniques include Harris corner detection, Shi-Tomasi Method, Features from Accelerated Segment Test (FAST), and Scale Invariant Feature Transform (SIFT) and Oriented FAST and Rotated BRIEF (ORB) (where BRIEF stands for Binary Robust Independent Elementary Features). Harris Corner Detection is effective when applied to structured, undistorted images, but is noise-sensitive and lacks robustness under fisheye distortion. Shi-Tomasi Method improves on Harris by refining eigenvalue-based criteria but offers limited performance in detecting curved or distorted targets. FAST allows for efficient real-time processing but may be inaccurate under high distortion and noise. SIFT and ORB offer scale and orientation invariance but requires substantial computational resources, making it less desirable for real-time vehicular systems.

Line detection techniques or line segment detection techniques include Canny edge detection, Line Segment Detector (LSD), and ED. Canny edge detection provides high gradient sensitivity, but requires a high edge detection threshold and may result in edge fragmentation. LSD may effectively detect elongated linear structures but requires high memory usage and results in false positive detections in complex environments. ED groups edges into continuous contours, preserving coherence, but requires enhanced constraints for robust real-time calibration.

Line segment detection techniques may be considered with respect to detection accuracy, detection speed, computational efficiency or complexity, robustness to noise, fisheye performance (i.e., robustness to fisheye distortion), and suitability for real-time applications, such as in a vehicular visions system. Edge Drawing Lines (EDLines) is another line segment detection technique that may be compared with Canny Edge Detection, LSD, and Multiscale Line Segment Detector (MLSD). Regarding detection accuracy, EDLines is highly precise and robust in detecting true line segments. Canny Edge Detection offers high edge detection accuracy but lacks explicit line detection. LSD has moderate detection accuracy but may produce false positive detections in complex scenes (e.g., images containing highly fragmented lines or objects, images containing a high density of objects, and/or images with high noise or distortion). MLSD has improved detection accuracy compared to LSD, especially in noisy environments (e.g., noisy image data and/or complex scenes).

Regarding speed of line segment detection and/or image processing, EDLines may provide good real-time performance, operating at higher speed than LSD and MLSD. Canny Edge Detection is fast but is limited to edge detection, requiring post-processing for line detection. LSD performs iterative refinement of line segments, and thus is slower than EDLines. MLSD uses multi-scale processing which is significantly slower than EDLines.

Regarding computational complexity, EDLines has low complexity compared to the other detection techniques discussed herein, using efficient edge grouping and validation techniques. Canny Edge Detection also has low complexity, using simple, gradient-based edge detection. LSD has higher complexity than EDLines due to its use of recursive partitioning and refinement. MLSD has even higher complexity than LSD, using multi-scale analysis and higher-order computations.

Regarding robustness to noise, EDLines is more robust than Canny Edge Detection, LSD, and MLSD. EDLines performs well, even when detecting line segments in noisy and distorted images, including fisheye images. Canny Edge Detection has moderate robustness, as noise can lead to fragmented edges. LSD also has moderate robustness, as noise can cause LSD to falsely detect line segments. MLSD has high robustness to noise, as it is designed for improved noise tolerance.

With respect to detecting line segments in fisheye images, EDLines is useful for fisheye image distortion, providing accurate line segment extraction. Canny Edge Detection is not designed for fisheye performance and requires preprocessing of fisheye images. Without distortion correction, line segment detection using LSD degrades with fisheye distortion. In comparison, MLSD has better performance with fisheye images than LSD, but requires significant adjustments to accommodate fisheye images.

Regarding suitability to real-time line segment detection applications, EDLines is highly suitable, effectively balancing accuracy and speed. Canny Edge Detection has limited ability to operate in real-time line detection applications, requiring further processing for line segmentation. LSD is also less suitable than EDLines, as high computational cost (i.e., time-intensive and/or processing-intensive computation) restricts its compatibility with real-time applications. MLSD is unsuitable for real-time applications, as it has very high computational cost.

That is, EDLines is effective in detecting line segments in distorted images, such as fisheye images, where other techniques or methods (including Canny Edge Detection, LSD, and MLSD) have lower detection capabilities due to the processes' inherent assumptions of linearity and uniform scaling. EDLines is computationally efficient and robust to noise, making it suitable for real-time applications, especially in applications such as automotive systems (e.g., vehicular vision systems) and robotics. Canny Edge Detection is computationally efficient but is oriented towards edge detection rather than line segments, requiring post-processing. LSD is accurate in simpler scenarios (e.g., when applied to images with low noise and distortion) but is prone to false positive detections in complex and/or noisy environments. LSD cannot process images with fisheye distortion without preprocessing. MLSD has improved accuracy over LSD. However, the high computational complexity of MLSD makes it impractical for real-time use, especially in embedded systems. EDLines has detection capabilities well suited for processing fisheye images or fisheye distortion and is highly suitable for real-time line segment detection, setting it apart from Canny Edge Detection, LSD, and MLSD.

Camera calibrations that use corner detection techniques or line segment detection techniques alone struggle or have limited detection capabilities when applied to distorted or noisy images, relying on manual region-of-interest selection and ad hoc adjustments. Accordingly, the detection techniques introduce inaccuracies and limited scalability. Methods and systems of camera calibration including corner detection and line extraction, as described herein, overcome limitations in detection capabilities.

The methods and systems of camera calibration described herein use line segment detection (i.e., line detection or line extraction) via ED, corner detection via line intersections, distortion compensation, and integration with calibration frameworks. ED uses gradient continuity to increase reliability of line detection. Corner detection via line intersection improves corner detection via sub-pixel refinement. Distortion compensation addresses pixel-shift bias via preprocessing steps. Integration with calibration frameworks includes automating ground-plane orientation and minimizing re-projection errors.

The camera calibration systems and methods include line detection using ED, corner detection via line intersection, addressing pixel-shift bias, and integration with calibration pipelines. Line detection using ED may include edge map generation, edge linking, and line extraction. Edge map generation may include computing gradients using Sobel operations. Edge map generation may further include applying Gaussian filtering for noise suppression (e.g., suppression of noise in image data). Edge linking may include grouping pixels of the image data into contours based on proximity of the pixels and gradient continuity (i.e., similarity in the gradients of the pixels). Line extraction may include fitting lines using random sample consensus (RANSAC) or least-squares optimization. Line extraction may validate line detections based on the slope, length and endpoints of a respective line.

Corner detection via line intersections may include adjacent line pairing, intersection calculation, and validation. Adjacent line pairing may include identifying neighboring lines using spatial and geometric alignment criteria. Intersection calculation may include computing intersections of line pairings, refining results to sub-pixel accuracy. Validation may include validating corner detections against calibration target geometry, such as a checkerboard pattern and/or a diamond pattern. That is, the camera calibration may determine a detected corner based, at least in part, on the corner matching a shape of the calibration target geometry. For example, validation may include comparing detected corners against the checkerboard pattern.

Addressing pixel-shift bias may include constraining lines to corner positions and preprocessing image data for distortion compensation. Line constraint may include using line slopes and endpoints to constrain corner positions and reducing inaccuracies caused by local gradient variations. Preprocessing image data for distortion compensation may include correcting fisheye distortion in images (i.e., image data) received as input, increasing reliability of corner estimation.

Integration with calibration pipelines may include ground-plane orientation, region-of-interest automation, and determining calibration outputs. Ground-plane orientation may include refining corner detection data and line extraction data for precise ground-plane calculations. That is, ground-plane orientation refines corner and line data for precise ground-plane calculations. Region-of-interest automation may include detecting calibration targets (e.g., objects located in the field of sensing of the camera or vision system) dynamically, eliminating manual selection or predetermination of regions of interest. Determining calibration outputs may include increasing accuracy of parameters such as pitch, roll, and yaw. For example, camera calibration may include determining calibration outputs that increase the accuracy of the ability of a vehicular vision system to determine parameters such as pitch, roll, and yaw of the equipped vehicle.

In some examples, camera calibration including corner detection and line extraction may include continuous edge detection via ED, line extraction and slope-based validation, and sub-pixel refinement of corner intersections. Optionally, the camera calibration may be integrated with calibration pipelines to improve ground-plane orientation and minimize reprojection errors. Additionally or alternatively, the camera calibration may further include correcting distortion in preprocessing of image data. Distortion correction in preprocessing may increase reliability of corner detection and line extraction for image data that includes fisheye distortion. Based on validated line and corner data, the camera calibration may automate region-of-interest selection.

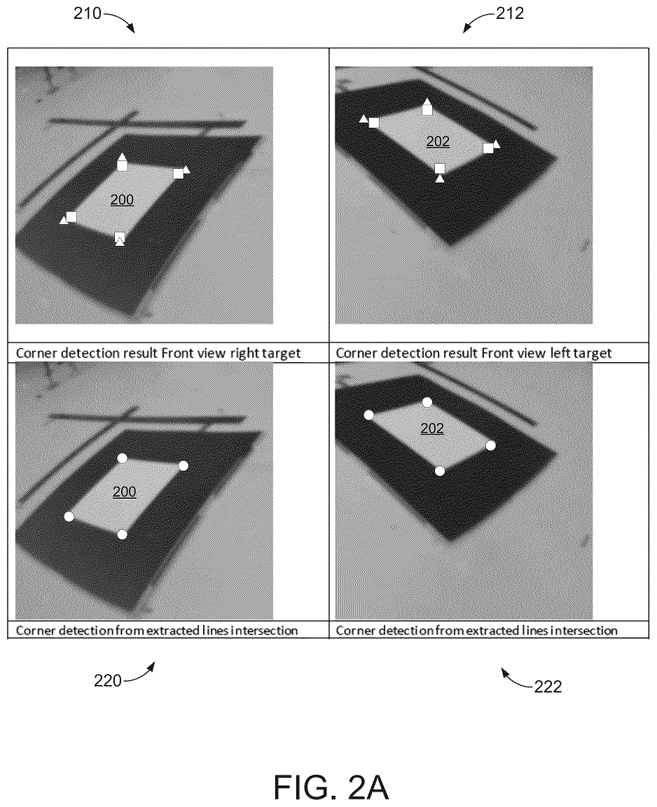

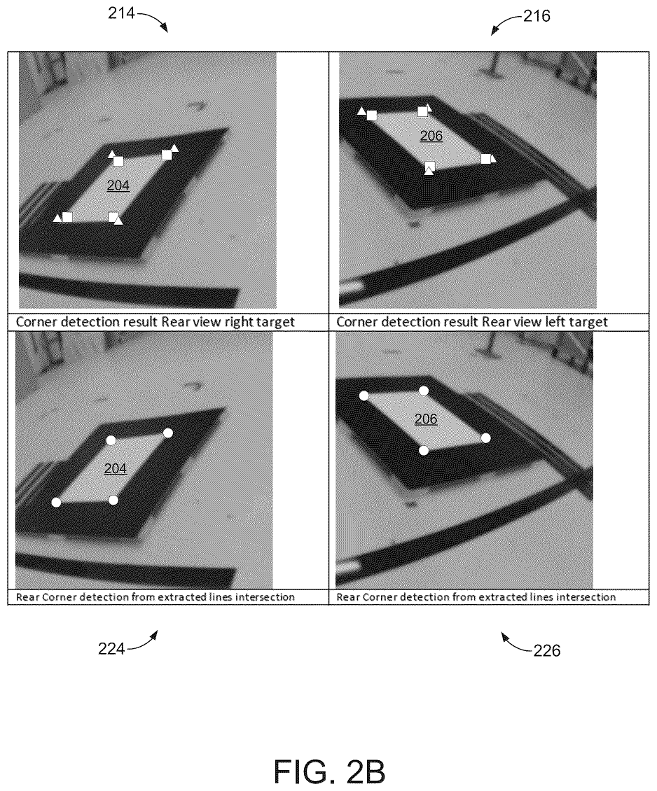

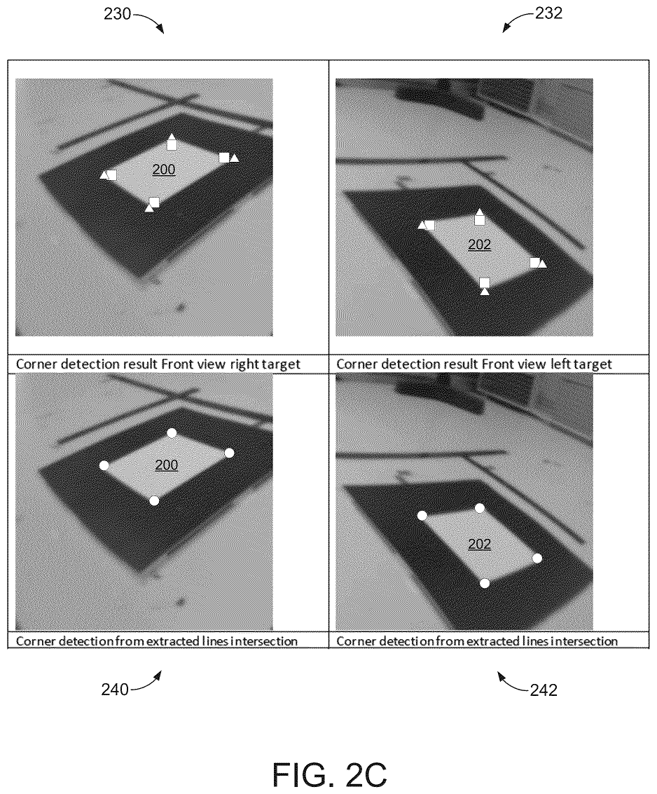

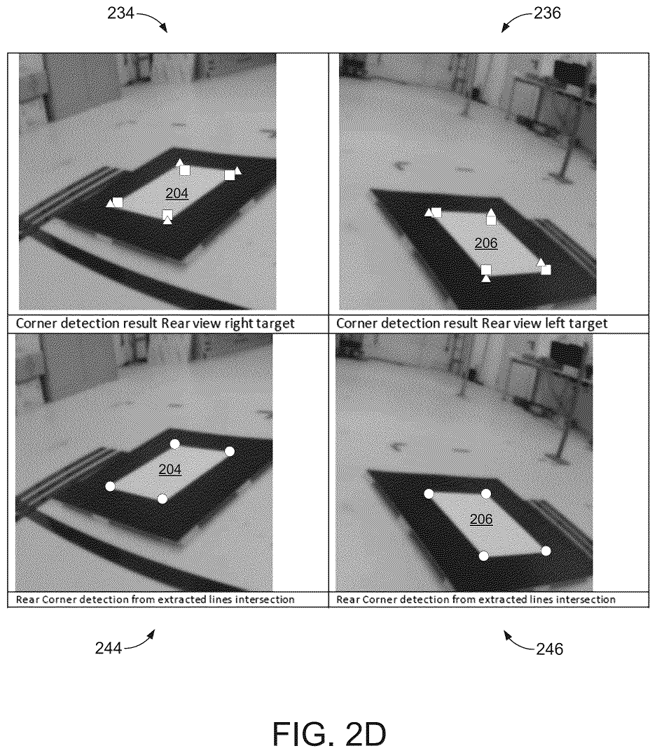

Direct corner detection of the corners of a target object may result in pixel shift, requiring adjustment to improve the accuracy of corner estimation. In contrast, camera calibration including corner detection and line extraction determines corners based on intersections of adjacent extracted lines, thus preventing pixel shift and eliminating the need for adjustment. Accordingly, camera calibration including corner detection and line extraction provides reliable and effective corner detection. FIG. 2A illustrates corner detection of the corners of a right target object 200 and a left target object 202 in a field of viewing of a front camera, such as a front camera of a vehicle. FIG. 2B illustrates corner detection of the corners of a right target object 204 and a left target object 206 in a field of viewing of a rear camera, such as a rear camera of a vehicle. The fields of viewing of the cameras are rotated −5° from their base orientations. Squares in images 210, 212, 214, and 216 represent corner detections determined using direct corner detection. The detections are offset by pixel shifting that results from direct corner detection. Direct corner detection methods may result in pixel shifts due to similarity or proximity of pixel intensity values. Accordingly, a camera calibration or vision system using direct corner detection must adjust corner detections to improve accuracy of final corner estimations. Triangles represent the adjusted corner estimations. That is, the squares represent corner detection determinations made before fine refinements by the direct corner detection method, and triangles represent the corner estimations made after refinement.

Circles in images 220, 222, 224, and 226 represent corner detections determined using camera calibration including corner detection and line extraction. Camera calibration using corner detection and line extraction detects corners based on intersections of adjacent extracted lines, thus requiring no adjustment and resulting in increased reliability and effectiveness.

FIG. 2C illustrates corner detection of the corners of a right target object 200 and a left target object 202 in a field of viewing of a front camera, such as a front camera of a vehicle. FIG. 2D illustrates corner detection of the corners of a right target object 204 and a left target object 206 in a field of viewing of a rear camera, such as a rear camera of a vehicle. The fields of viewing of the cameras are rotated +5° from their base orientations. Triangles in images 230, 232, 234, and 236 represent corner detections determined using direct corner detection. The detections are offset by pixel shifting that results from direct corner detection. Direct corner detection methods may result in pixel shifts due to similarity or proximity of pixel intensity values. Accordingly, a camera calibration or vision system using direct corner detection must adjust corner detections to improve accuracy of final corner estimations. Squares represent the adjusted corner estimations. That is, the triangles represent corner detection determinations made before fine refinements by the direct corner detection method, and squares represent the corner estimations made after refinement.

Circles in images 240, 242, 244, and 246 represent corner detections determined using camera calibration including corner detection and line extraction. Camera calibration using corner detection and line extraction detects corners based on intersections of adjacent extracted lines, thus requiring no adjustment and resulting in increased reliability and effectiveness.

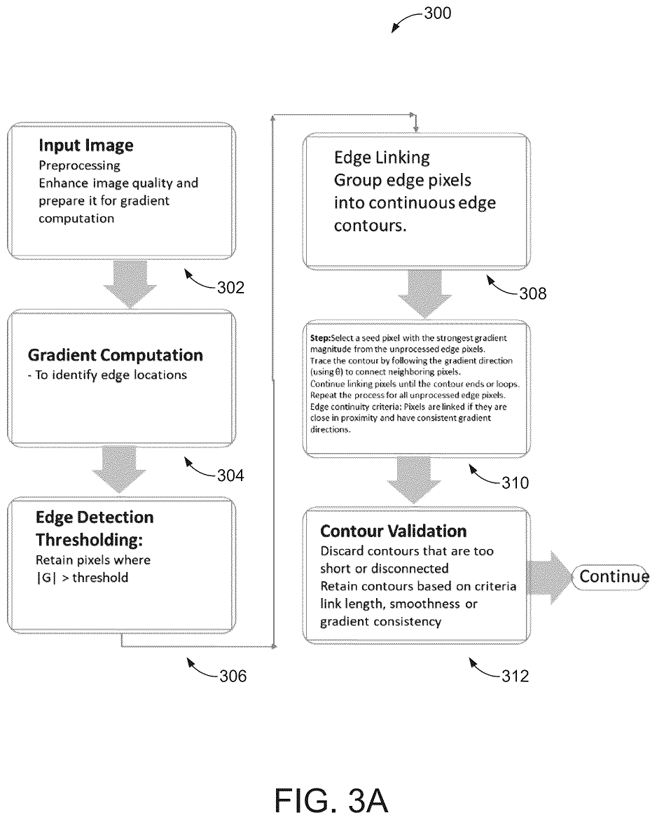

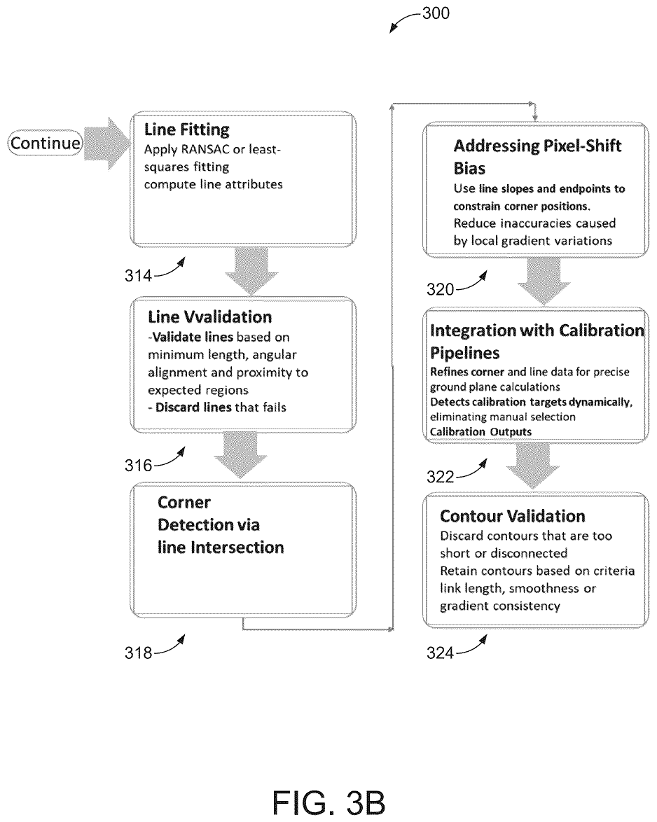

FIGS. 3A and 3B illustrate a flowchart of the camera calibration method 300 including corner detection and line extraction. The line extraction process may include determining edge continuity and line validation. Corner detection or corner estimation process may include depicting and/or determining intersections of extracted lines.

At operation 302, the camera calibration 300 receives image data as an input. The image data may be preprocessed, increasing image quality and preparing the image data for gradient computation (i.e., gradient determination). Optionally, preprocessing may include processing, by the image processor, of the image data for optical distortions. At operation 304, the gradient computation may be performed to identify edge locations. Edge detection threshold determination, at operation 306, may identify pixels as representing a portion of an edge and/or retain pixels of the image data where an edge gradient, G, of the pixels has an absolute value greater than a threshold value. For example, edge detection threshold determination may include determining, for each pixel having a gradient magnitude with an absolute value greater than a threshold value, that the respective pixel represents a portion of the respective edge. Edge detection threshold determinations filter the image data for noise suppression.

Edge linking, at operation 308, may include grouping edge pixels into continuous edge contours. For example, pixels retained from the edge detection threshold determinations may be grouped into continuous edge contours. At operation 310, the camera calibration may select, from unprocessed edge pixels, a seed pixel with the strongest gradient magnitude. Contours are traced and/or determined by following the gradient direction (e.g., using angle θ of the gradient) to connect neighboring pixels. The camera calibration may continue linking pixels until the contour ends or loops. The pixel linking process may be repeated for all unprocessed edge pixels. Pixel linking may be based on edge continuity criteria, such as linking pixels if the pixels are close in proximity and have consistent gradient directions. That is, an unprocessed pixel may be linked to the linked pixels if the unprocessed pixel is close in proximity (e.g., an adjacent pixel) to the linked pixels and if the unprocessed pixel has a gradient consistent with the gradient direction of the linked pixels.

Contour validation, at operation 312, may include discarding contours that have a length less than a threshold length or discarding contours that are disconnected. Contour validation may also include determining and/or retaining contours based on criteria such as link length (i.e., a length of a group of pixels of a contour), smoothness of the contour, or gradient consistency of pixels representing a respective contour. In one example, a respective contour may be retained if the link length of the contour is greater than a threshold value and/or is greater than the threshold length for contour discarding. In another example, a respective contour may be retained if the contour has a smoothness that exceeds a threshold smoothness. In a further example, a respective contour may be retained if the contour has a gradient consistency that exceeds a threshold gradient consistency. Optionally, contour validation may retain a contour based on any combination of link length, smoothness, and gradient determinations.

Line fitting (i.e., determining a line), at operation 314, may include applying RANSAC or least-squares fitting (i.e., least-squares optimization) to compute line attributes. For example, line fitting may include determining a line by applying RANSAC or least-squares fitting to a validated contour to determine line attributes. Line validation, at operation 316, may include validating lines based on validation criteria, such as a threshold length and/or angular alignment and proximity to expected regions. That is, lines may be determined and/or retained based on the length of the line exceeding a threshold length, the line having angular alignment (e.g., the line having angular alignment with a determined edge), and/or the line being proximate to an expected region. For example, lines that have an angle within a threshold of degrees of an angle of a determined edge may be retained. Line validation may further include discarding lines that fail to meet validation criteria. In one example, lines that have a length less than the threshold length may be discarded. In another example, lines that have an angle outside of a threshold of degrees of an angle of a determined edge may be discarded. At operation 318, corner detection is determined via line intersection. For example, intersections of lines determined through the line extraction, as performed during operations 302 to 316, may be used to determine corners of a target object. Optionally, corner detection may include validating corner detections against calibration target geometry, such as a checkerboard pattern and/or a diamond pattern. At operation 320, pixel-shift bias is addressed using line slopes and endpoints to constrain corner positions. By addressing pixel-shift bias, inaccuracies caused by local gradient variations are reduced. Integration with calibration pipelines, at operation 322, may include refining corner data and line data for precise ground-plane calculations. Through integration with calibration pipelines, the camera calibration may detect calibration targets dynamically, eliminating manual selection of regions of interest within the image data. That is, through integration with calibration pipelines, the camera calibration may detect calibration targets dynamically without requiring manual selection of regions of interest within image data. Integration with calibration pipelines may further determine calibration outputs. In examples of vehicular camera calibration, determining calibration outputs may increase accuracy of determining parameters such as pitch, roll, and yaw of the vehicle.

Optionally, the camera calibration 300 may further include contour validation, at operation 324. Contour validation may include discarding contours that have lengths less than a minimum length threshold or discarding disconnected contours. Contour validation may further include retaining contours based on criteria such as link length, smoothness, or gradient consistency. That is, contour validation includes determining a respective contour of a respective edge (i.e., retaining the contour) based on the contour having a length that exceeds a threshold length, the contour having a smoothness that exceeds a threshold smoothness, and the contour having a gradient consistency that exceeds a threshold gradient consistency. For example, a respective contour may be retained if the link length of the contour is greater than a threshold value and/or is greater than the threshold length for contour discarding.

By combining ED-based line extraction and intersection-driven corner detection, the camera calibration methods and systems described herein may provide highly accurate and robust vehicular camera calibration. Combining ED-based line extraction and corner detection increases corner detection and line segment detection accuracy while maintaining a computational speed and/or efficiency that is suitable for real-time image processing applications. Integrating ED-based line extraction and corner detection with camera calibration frameworks improves reliability of corner detection performance across diverse image processing scenarios. Accordingly, although the disclosed camera calibration has been described herein with respect to vehicular camera calibration, camera calibration including corner detection and line extraction may be applied to the calibration of any image sensor, camera, imaging system, or camera system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements, preferably at least 500,000 photosensor elements and more preferably at least one million photosensor elements or at least two million photosensor elements or at least three million photosensor elements or at least five million photosensor elements arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in U.S. Pat. Nos. 10,071,687; 9,900,522; 9,834,153; 9,762,880; 9,596,387; 9,264,672; 9,126,525 and/or 9,041,806, and/or U.S. Publication No. US-2015-0022664, which are hereby incorporated herein by reference in their entireties.

Optionally, the display may be viewable through a reflective element of a mirror assembly when the display is activated to display information. Optionally, the display element may comprise any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a camera disposed at a vehicle equipped with the vehicular vision system and viewing exterior of the vehicle, the camera capturing image data;
wherein the camera comprises an imager, and wherein the imager comprises a CMOS imaging array having at least one million photosensors arranged in rows and columns;
an electronic control unit (ECU) comprising electronic circuitry and associated software;
wherein the electronic circuitry of the ECU comprises an image processor for processing image data captured by the camera to detect presence of objects within a field of view of the camera;
wherein the vehicular vision system, at least in part via processing at the ECU of image data captured by the camera, detects edges of an object;
wherein the vehicular vision system, based at least in part on the detected edges of the object, extracts lines representative of the detected edges and performs slope-based validation of the extracted lines; and
wherein the vehicular vision system determines corners of the object by determining intersections of the validated extracted lines.

2. The vehicular vision system of claim 1, wherein detecting edges of the object comprises determining, for each respective edge, gradients of pixels of the captured image data that represent respective points along the respective edge, and determining, based on the determined gradients of pixels, the respective edge.

3. The vehicular vision system of claim 2, wherein the gradients of pixels are determined based at least in part on Sobel operations.

4. The vehicular vision system of claim 2, wherein determining the respective edge further comprises determining, for each respective pixel having a gradient magnitude with an absolute value greater than a threshold value, that the respective pixel represents a portion of the respective edge.

5. The vehicular vision system of claim 2, wherein, based on the determined gradients of the pixels of the determined respective edge, the vehicular vision system determines a plurality of contours of the determined respective edge, and wherein, based on the plurality of contours of the determined respective edge, the vehicular vision system extracts a line representative of the determined respective edge.

6. The vehicular vision system of claim 5, wherein determining the plurality of contours of the determined respective edge further comprises (i) selecting, from pixels of the captured image data having a gradient magnitude greater than a threshold value, a seed pixel having a strongest gradient magnitude, (ii) determining, based on the seed pixel, a direction of a respective gradient, and (iii) linking the seed pixel with other pixels of the captured image data that (a) are proximate to the seed pixel and (b) have a gradient direction consistent with the direction of the respective gradient.

7. The vehicular vision system of claim 5, wherein determining the plurality of contours of the determined respective edge further comprises retaining a respective contour of the plurality of contours based at least in part on (i) the respective contour having a length that exceeds a threshold length, (ii) the respective contour having a smoothness that exceeds a threshold smoothness, and (iii) the respective contour having a gradient consistency that exceeds a threshold gradient consistency.

8. The vehicular vision system of claim 1, wherein line extraction further comprises retaining a respective line of the extracted lines based at least in part on a length of the respective line exceeding a threshold length.

9. The vehicular vision system of claim 1, wherein line extraction further comprises determining each line of the extracted lines based on at least one selected from the group consisting of (i) random sample consensus (RANSAC) and (ii) least-squares optimization.

10. The vehicular vision system of claim 1, wherein the vehicular vision system determines a slope of each line of the extracted lines and determines an endpoint of each line of the extracted lines, and wherein the vehicular vision system addresses pixel-shift bias of the determined corners by constraining positions of the determined corners based on (i) the determined slope of each line of the extracted lines and (ii) the determined endpoint of each line of the extracted lines.

11. The vehicular vision system of claim 10, wherein the vehicular vision system determines, based at least in part on (i) the slope-based validation of the extracted lines and (ii) the constrained positions of the determined corners of the object, a ground plane on which the vehicle is traveling.

12. The vehicular vision system of claim 1, wherein the image processor preprocesses the image data for optical distortions.

13. The vehicular vision system of claim 1, wherein determining corners of the object further comprises determining that a respective corner matches a shape of a calibration target geometry.

14. A method of operating a vehicular vision system, the method comprising:
capturing image data via a camera disposed at a vehicle equipped with the vehicular vision system and viewing exterior of the vehicle;
wherein the camera comprises an imager, and wherein the imager comprises a CMOS imaging array having at least one million photosensors arranged in rows and columns;
processing, at an image processor of an electronic control unit (ECU) comprising electronic circuitry and associated software, the captured image data to detect presence of objects within a field of view of the camera;
detecting, at least in part via processing at the ECU of the captured image data, edges of an object;
extracting, based at least in part on the detected edges of the object, lines representative of the detected edges and performing slope-based validation of the extracted lines; and
determining corners of the object by determining intersections of the validated extracted lines.

15. The method of claim 14, wherein detecting edges of the object comprises determining, for each respective edge, gradients of pixels of the captured image data that represent respective points along the respective edge, and determining, based on the determined gradients of pixels, the respective edge.

16. The method of claim 15, wherein the gradients of pixels are determined based at least in part on Sobel operations.

17. The method of claim 15, wherein determining the respective edge further comprises determining, for each respective pixel having a gradient magnitude with an absolute value greater than a threshold value, that the respective pixel represents a portion of the respective edge.

18. The method of claim 15, further comprising determining, based on the determined gradients of the pixels of the determined respective edge, a plurality of contours of the determined respective edge, and extracting, based on the plurality of contours of the determined respective edge, a line representative of the determined respective edge.

19. The method of claim 18, wherein determining the plurality of contours of the determined respective edge further comprises (i) selecting, from pixels of the captured image data having a gradient magnitude greater than a threshold value, a seed pixel having a strongest gradient magnitude, (ii) determining, based on the seed pixel, a direction of a respective gradient, and (iii) linking the seed pixel with other pixels of the captured image data that (a) are proximate to the seed pixel and (b) have a gradient direction consistent with the direction of the respective gradient.

20. The method of claim 18, wherein determining the plurality of contours of the determined respective edge further comprises retaining a respective contour of the plurality of contours based at least in part on (i) the respective contour having a length that exceeds a threshold length, (ii) the respective contour having a smoothness that exceeds a threshold smoothness, and (iii) the respective contour having a gradient consistency that exceeds a threshold gradient consistency.
